(19) United States
(12) Patent Application Publication
(10) Pub. No.: US 2009/0314855 A1
(43) Pub. Date: Dec. 24, 2009

(54) VECTOR OR SWIRL SHAPING AIR

(75) Inventor: David M. Seitz, Riga, MI (US)

Correspondence Address: BARNES & THORNBURG LLP, 11 SOUTH MERIDIAN, INDIANAPOLIS, IN, 46204, US

(73) Assignee: ILLINOIS TOOL WORKS INC., Glenview, IL (US)

(21) Appl. No.: 12/141,204

(22) Filed: Jun. 18, 2008

(51) Int. Cl. B05B 3/04

(52) U.S. Cl. 239/263

(57) ABSTRACT

A coating material dispenser includes a motor provided in a housing and a bell cup mounted to the motor for rotation about an axis of rotation. The housing includes shaping gas outlet holes provided on a circle having a center on the axis of rotation. Each hole has a longitudinal axis which makes a non-zero angle with a line which passes through an opening of the hole from the housing and extends parallel to the axis of rotation.

### FIELD OF THE INVENTION

This invention relates to atomizers for atomizing and dispensing fluent coating materials (hereinafter sometimes paints).

### BACKGROUND OF THE INVENTION

Systems for dispensing coating materials are known. There are, for example, the systems illustrated and described in U.S. Pat. Nos. 2,890,388; 2,960,273; 3,393,662; 3,408,985; 3,536,514; 3,575,344; 3,608,823; 3,698,636; 3,843,054; 3,913,523; 3,952,951; 3,964,683; 4,037,561; 4,039,145; 4,114,564; 4,114,810; 4,135,667; 4,143,819; 4,169,560; 4,216,915; 4,228,961; 4,360,155; 4,381,079; 4,447,008; 4,450,785; Re. 31,867; U.S. Pat. Nos. 4,520,754; 4,580,727; 4,598,870; 4,685,620; 4,760,965; 4,771,949; 4,784,331; 4,788,933; 4,798,340; 4,802,625; 4,811,898; 4,825,807; 4,852,810; 4,872,616; 4,921,172; 4,943,005; 4,997,130; 5,085,373; 5,353,995; 5,358,182; 5,433,387; 5,582,347; 5,622,563; 5,633,306; 5,662,278; 5,720,436; 5,803,372; 5,853,126; 5,957,395; 6,012,657; 6,042,030; 6,076,751; 6,230,993; 6,322,011; 6,328,224; 6,676,049; 6,793,150; 6,889,921; and, 7,128,277. There are also the devices illustrated and described in published U.S. patent applications: US 2004/0061007; US 2005/0035229; and WO 03/031075. There are also the devices illustrated and described in U.S. Pat. Nos. 2,759,763; 2,877,137; 2,955,565; 2,996,042; 3,102,062; 3,233,655; 3,578,997; 3,589,607; 3,610,528; 3,684,174; 4,066,041; 4,171,100; 4,214,708; 4,215,818; 4,323,197; 4,350,304; 4,402,991; 4,422,577; Re. 31,590; U.S. Pat. Nos. 4,505,430; 4,518,119; 4,726,521; 4,779,805; 4,785,995; 4,879,137; 4,890,190; 4,896,384; 4,955,960; 5,011,086; 5,058,812; and, 5,632,448; European patent application 0 509 101 A1; British Patent Specification 1,209,653; Japanese published patent applications: PCT/JP2005/018045; 62-140,660; 1-315,361; 3-169,361; 3-221,166; 60-151,554; 60-94,166; 63-116,776; 2004-272447; 58-124,560; and 331,823 of 1972; and, French patent 1,274,814. There are also the devices illustrated and described in “Aerobell™ Powder Applicator ITW Automatic Division;” “Aerobell™ & Aerobell Plus™ Rotary Atomizer, DeVilbiss Ransburg Industrial Liquid Systems;” and, “Wagner PEM-C3 Spare parts list.” The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, a coating material dispenser includes a motor provided in a housing and a bell cup mounted to the motor for rotation about an axis of rotation. The housing includes shaping gas outlet holes provided on a circle having a center on the axis of rotation. Each hole has a longitudinal axis which makes a non-zero angle with a line which passes through an opening of the hole from the housing and extends parallel to the axis of rotation.

Illustratively, the longitudinal axes of the gas outlet holes are angled at the non-zero angles toward the axis of rotation of the motor.

Further illustratively, the apparatus includes first and second sets of shaping gas outlet holes. The holes of the first set have longitudinal axes. The holes of the second set have longitudinal axes. The holes of the first set lie generally on a first circle having a first diameter and the holes of the second set lie generally on a second circle having a second larger diameter than the first diameter.

Illustratively, the longitudinal axis of each hole of the first set makes a non-zero angle with a line which passes through an opening of the hole of the first set and extends parallel to the axis of rotation. The longitudinal axis of each hole of the first set further makes a second non-zero angle with a line which passes through an opening of the hole of the first set and is angled toward the axis of rotation of the motor. The longitudinal axis of each hole of the second set makes a non-zero angle with a line which passes through an opening of the hole of the second set and extends parallel to the axis of rotation.

Illustratively, the holes of the first set are provided with compressed gas through a first control and the holes of the second set are provided with compressed gas through a second control separate from the first control.

### BRIEF DESCRIPTION OF THE DRAWINGS

The invention may best be understood by referring to the following detailed description and accompanying drawings which illustrate the invention. In the drawings:

FIG. 1 illustrates some relationships useful in understanding the invention;

FIG. 2 illustrates a longitudinal sectional side elevational view of an apparatus incorporating the invention;

FIG. 3 illustrates a longitudinal sectional side elevational view of an apparatus incorporating the invention;

FIG. 4a illustrates a perspective view of a detail of an apparatus constructed as illustrated in FIG. 2;

FIG. 4b illustrates a front elevational view of the detail illustrated in FIG. 4a;

FIG. 4c illustrates a longitudinal sectional side elevational view of the detail illustrated in FIGS. 4a-b, taken generally along section lines 4c-4c of FIG. 4b;

FIG. 4d illustrates a sectional view of the detail illustrated in FIGS. 4a-c, taken generally along section lines 4d-4d of FIG. 4b;

FIG. 5a illustrates a perspective view of a detail of an apparatus constructed as illustrated in FIG. 3;

FIG. 5b illustrates a front elevational view of the detail illustrated in FIG. 5a;

FIG. 5c illustrates a side elevational view of the detail illustrated in FIGS. 5a-b;

FIG. 5d illustrates a sectional view of the detail illustrated in FIGS. 5a-c, taken generally along section lines 5d-5d of FIG. 5c;

FIG. 6a illustrates a side elevational view of a detail of an apparatus constructed as illustrated in FIG. 3;

FIG. 6b illustrates a sectional view of the detail illustrated in FIG. 6a, taken generally along section lines 6b-6b of FIG. 6a;

FIG. 7a illustrates a side elevational view of a detail of an apparatus constructed as illustrated in FIG. 3;

FIG. 7b illustrates a sectional view of the detail illustrated in FIG. 7a, taken generally along section lines 7b-7b of FIG. 7a;

FIG. 8a illustrates a side elevational view of a detail of an apparatus constructed as illustrated in FIG. 3; and,

FIG. 8b illustrates a sectional view of the detail illustrated in FIG. 8a, taken generally along section lines 8b-8b of FIG. 8a.

### DETAILED DESCRIPTION OF ILLUSTRATIVE EMBODIMENTS

There are basically two technologies in rotary spray application, one providing a larger “soft” spray pattern, and the other a smaller “hard” spray pattern. Soft pattern technology relies more on the rotational speed of the bell cup to achieve atomization. The shaping air is used to move the atomized coating material particles towards the intended target. Hard pattern technology, on the other hand, relies on higher pressures and larger volumes of air to aid in atomizing coating material from the edge of the bell cup. The higher volume airflow both shapes and pushes the pattern toward the object to be coated, or target. These technologies work well independently. Heretofore, however, it has been difficult to provide a single system capable of delivering to the user the benefits of both soft and hard pattern technologies.

Soft pattern technology provides pattern flexibility over a wide range of sizes, but requires higher rotational speeds for atomization. Higher speeds are good for atomizing high flows of paint but it is more difficult to shape the pattern of coating material particles atomized under high rotational speed conditions. Additionally, higher rotational speeds generally translate into more maintenance on equipment. Further, painting of small, tight areas is more difficult to achieve with soft pattern technology.

Soft pattern shaping air devices generally may be located anywhere from just behind the bell cup and outside the diameter of the front, discharge edge of the bell cup to relatively farther back from the discharge edge and inside the bell cup diameter. Soft patterns generally have diameters in the range of about 10 inches diameter to about 24 inches diameter—about 25.4 cm to about 61 cm—at a distance of about 8 inches to about 12 inches—about 20.3 cm to about 30.5 cm—from the target.

Hard pattern technology generally provides more limited pattern flexibility, owing to its use of relatively larger amounts of air for atomization. On the other hand, hard pattern technology has the benefit that it requires relatively more moderate bell cup rotation rates. It is easier to get paint into tight areas. However, larger flat surfaces require more cycle time (sometimes in the form of extra passes of the article to be coated by the coating dispensing equipment) to obtain suitable coverage. Typically these atomizers are limited to somewhat more modest amounts, such as, for example, 350 cc/min., of paint flow.

Normal hard pattern shaping air devices are typically located, for example, in the range of 1-12 mm behind, and outside the diameter of the front, discharge edge of the bell cup. Hard patterns generally have diameters in the range of about 3 inches diameter to about 12 inches diameter—about 7.6 cm to about 30.5 cm—at a distance of about 7 inches to about 12 inches—about 17.8 cm to about 30.5 cm—from the target.

These interrelationships of the variables of atomizer rotation rate and shaping air volume, as well as their effects on pattern width, are best illustrated in FIG. 1. As illustrated in FIG. 1, generally at lower consumptions of shaping air (in standard liters per minute, or slpm), pattern width generally increases with increasing flow rate of coating material to the atomizer. This relationship holds generally up to about 350 slpm and 70,000 rpm (70 Krpm). At some point between 350 slpm and 450 slpm, however, this relationship inverts. At that point, generally narrower patterns are achieved with increasing flow rates of coating material to the atomizer at turbine rotation rates between about 50 Krpm and about 70 Krpm.

The illustrated systems provide the flexibility to produce a larger, softer pattern and a smaller, harder pattern with the same equipment.

The illustrated systems incorporate a bell cup 20, 120 having a diameter of about 65 mm and shaping air configurations to produce acceptable atomization desirable for both large soft pattern spray (generally the entries up to about 70 Krpm/350 slpm of shaping air in FIG. 1) and hard pattern sprays (generally the entries to the right of about 70 Krpm/350 slpm of shaping air in FIG. 1). When a large pattern is desirable the atomizer motor 22, 122 speed can be increased to mechanically atomize the paint and the shaping air 24, 124 can be adjusted to the desired flow rate/volume in slpm to paint larger targets 26, 126. Conversely, the rotational speed of the atomizer motor 22, 122 can be reduced and the shaping air 24, 124 flow rate/volume increased to obtain the smaller hard pattern configuration for smaller targets 26, 126. The illustrated systems also permit the achievement of hard patterns at higher flow rates/volumes by using higher atomizer motor 22, 122 speeds to atomize the paints.

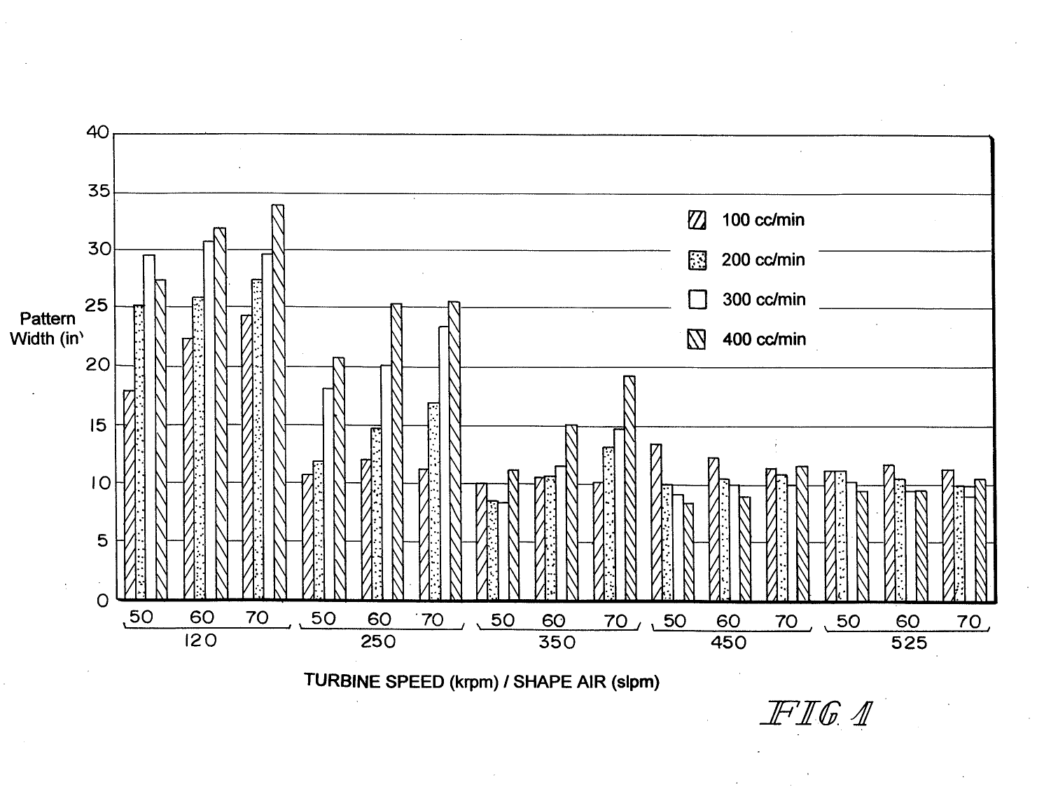

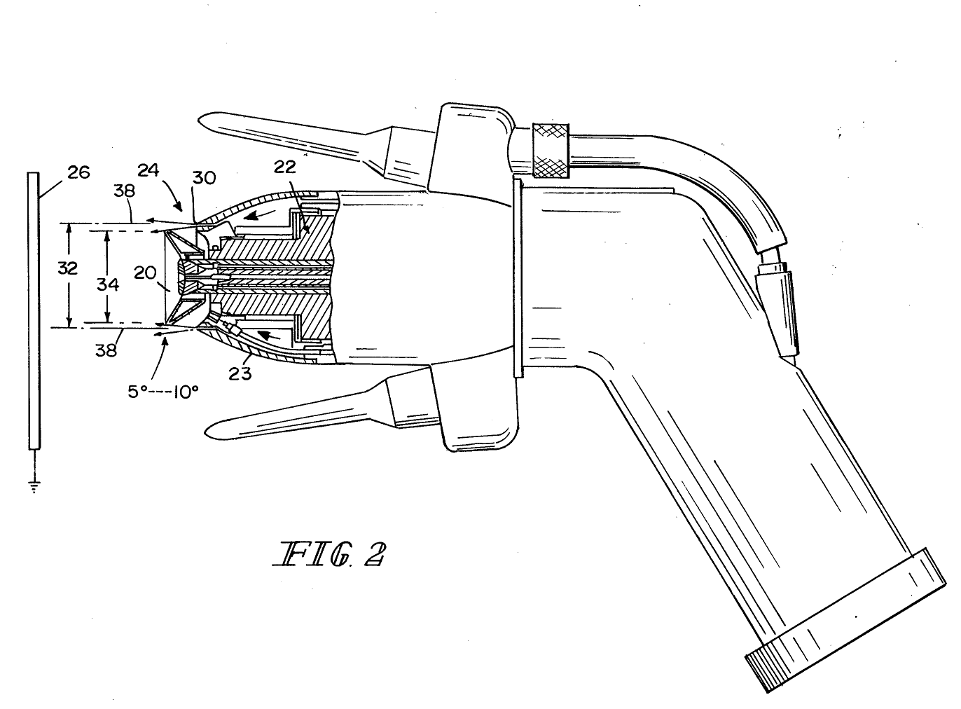

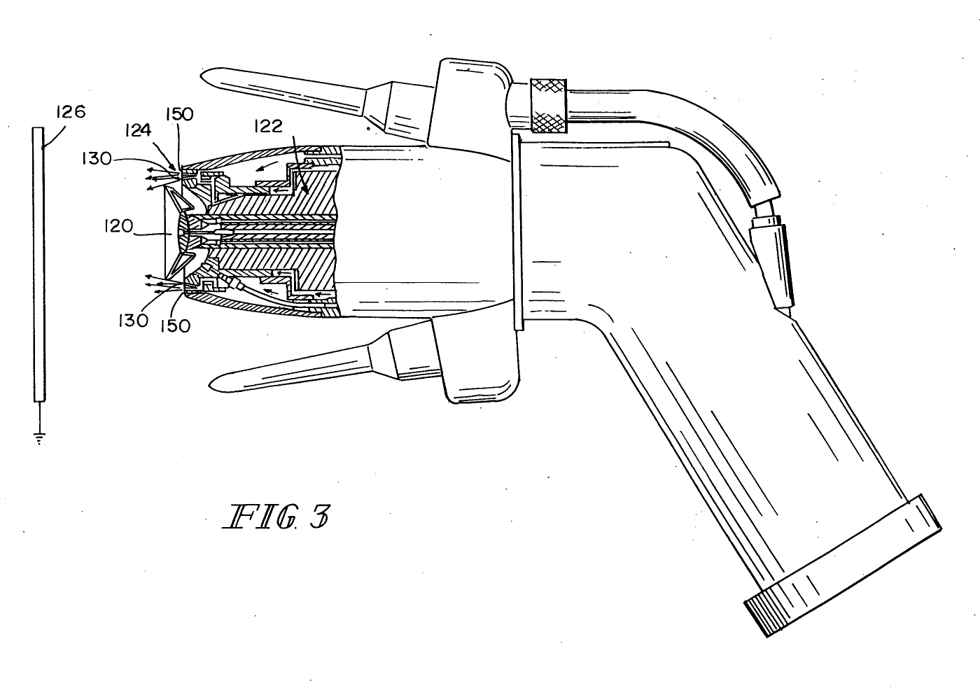

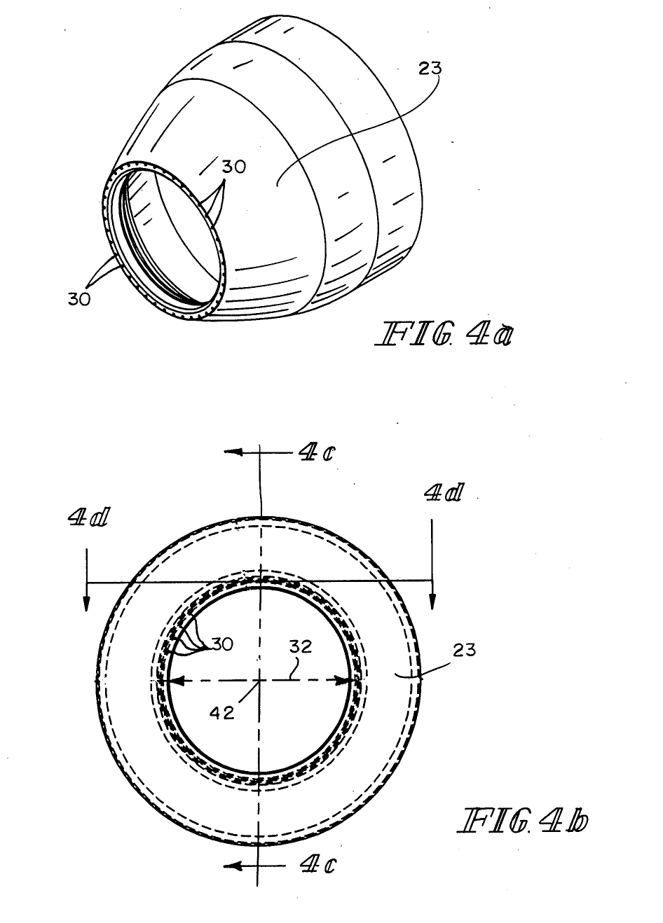

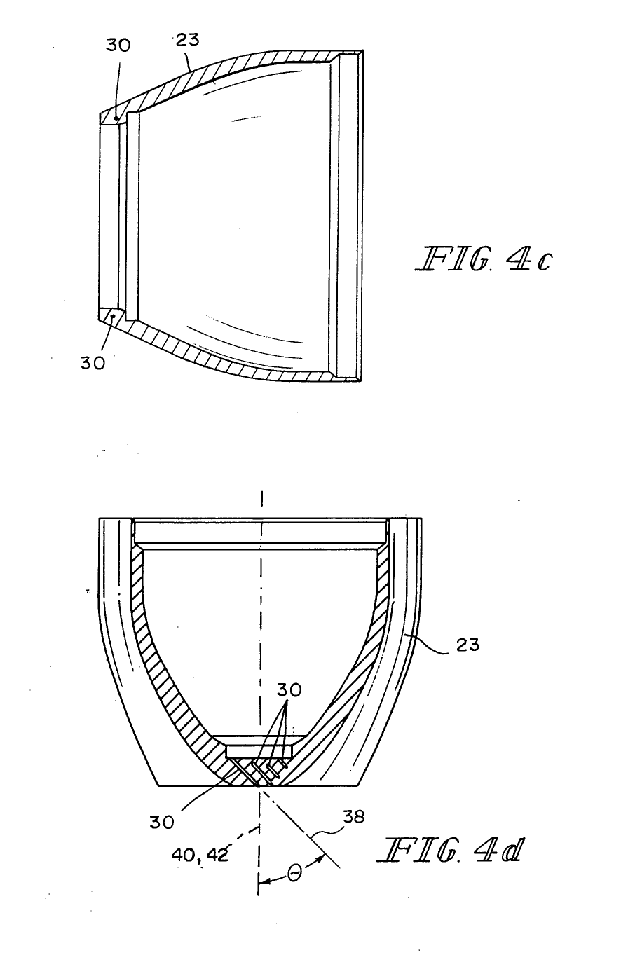

In one embodiment illustrated in FIGS. 2 and 4a-d, a single plurality of shaping air outlet holes 30 are placed with their centers on a diameter 32 at the forward end of the motor 22 housing 23 outside the bell cup 20 diameter 34 and behind the bell cup 20's atomizing edge 36 about 18 mm. The diameter outside the bell cup 20 and the distance behind the bell cup 20's atomizing edge 36 are calculated from the diameter 34 of the bell cup 20, the diameter 32 of the array of air outlet holes 30 and the knowledge that air expands from holes of the general size of outlet air holes 30 at an angle in the range of about 5° to about 10° from the axis of the hole. The axes 38 of the outlet air holes 30 are angled at angles θ (in a range of about 0° to about 45°) counter to respective lines 40 parallel to the axis 42 of rotation of the bell cup 20, but on circle 32 centered on the axis 42 of rotation of the bell cup 20. The axes 38 of the holes can also be angled inward at angles φ (about 0° to about 15°) to respective lines 40 toward the axis 42 of bell cup 20.

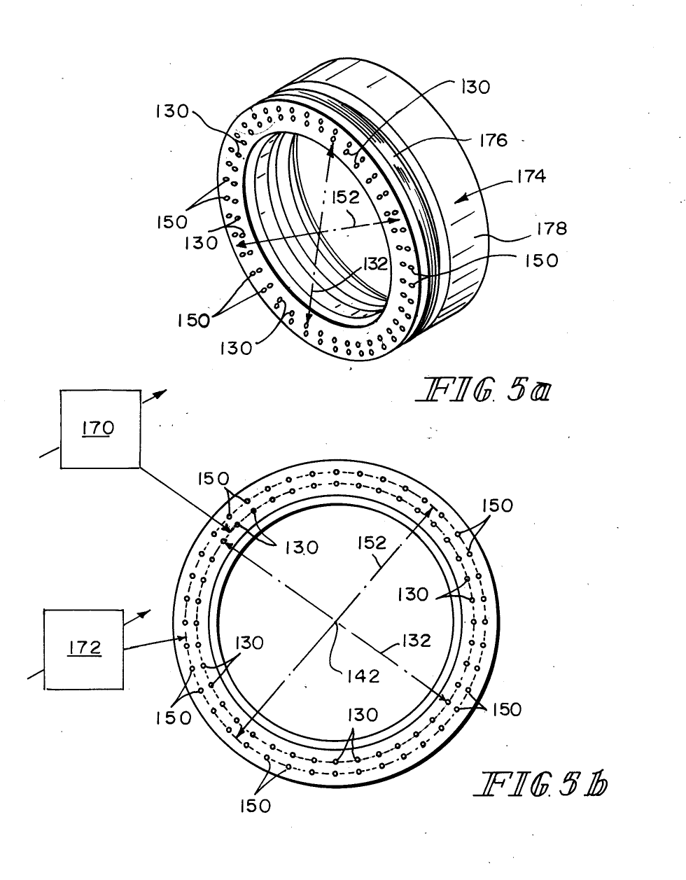

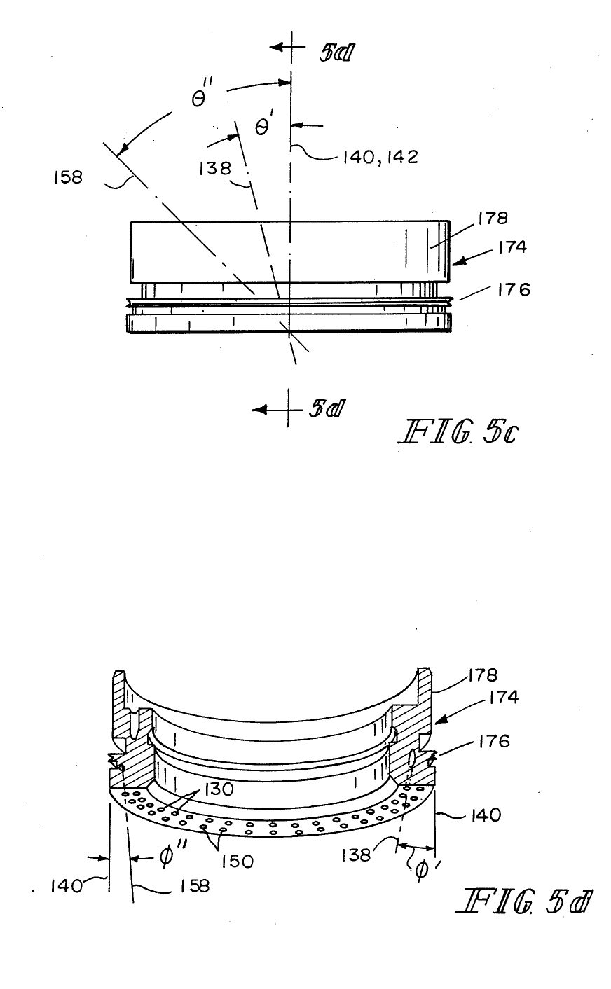

In a second embodiment illustrated in FIGS. 3, 5a-d, 6a-b, 7a-b and 8a-b, two sets of holes 130, 150 on different diameters 132, 152, respectively, are used to create a small pattern. The holes 130 of the inner set are angled at angles θ′ (in a range of about 0° to about 45°) counter to respective lines 140 parallel to the axis 142 of rotation of the bell cup 120 on a circle 132 centered on the axis 142 of rotation of the bell cup 120. The axes 138 of holes 130 can also be angled inward at angles φ′ (about 0° to about 15°) to respective lines 140 toward the axis 142 of bell cup 120. The axes 158 of outer holes 150 are angled at angles θ″ (about 0° to about 45°) counter to respective lines 140 parallel to the axis 142 of rotation of the bell cup 120 on a circle 150 centered on the axis 142 of rotation of the bell cup 120. The axes 158 of outer holes 150 can also be angled inward at angles φ″ (about 0° to about 15°) toward the axis 142 of bell cup 120. The air streams from the inner set 130 of holes and from the outer set 150 of holes can be supplied from a common compressed air source, or can be independently controlled 170, 172, respectively. With this embodiment, a user can, for example, switch from painting larger, flatter surfaces of target 126 using only the outer set 150 of holes to using only the inner set 130 of holes to paint deep, small cavities of target 126 with the air supply 172 to the outer set 150 of holes turned off. This is effective, for example, when painting targets 126 such as automobile fascias where both larger flatter surfaces and smaller deeper cavities need to be coated using the same equipment.

FIGS. 4a-d illustrate a single vortex embodiment. The shaping air outlet holes 30 angle 45° (angle θ=45°) forward toward the front of the housing 23 (FIG. 4d) and exhaust in the direction (clockwise in this embodiment) opposite to the direction of rotation of the bell cup 20 (counterclockwise in this embodiment). Holes 30 do not angle inward toward the axis 42 of the bell cup 20 (angle φ=0°). In this embodiment there are forty shaping air outlet holes 30 (FIG. 4a) spaced equally at 9° intervals about the bell cup 20 axis 42 of rotation. The diameters of the holes 30 in this embodiment are about 0.030″ (about 0.762 mm).

FIGS. 5a-d illustrate a dual outlet holes 130, 150 embodiment. A shaping air ring 174 in which the shaping air outlet holes 130, 150 are provided includes threads 176 on an outside surface 178 thereof to mate with complementary threads (not shown) on the inside of the front end of a housing similar to housing 23. The inner shaping air outlet holes 130 angle forward 15° (angle θ′=15°, FIG. 5c) and inward toward the axis 142 of rotation of the bell cup 120 at an angle of 10° (angle φ′=10°, FIG. 5d) and exhaust in the direction (clockwise in this embodiment) opposite to the direction of rotation of the bell cup 20 (counterclockwise in this embodiment). In this embodiment there are forty shaping air outlet holes 130 (FIGS. 5a-b) spaced equally at 9° intervals about the bell cup 120 axis 142 of rotation. The diameters of the holes 130 in this embodiment are about 0.030″ (about 0.762 mm). The outer shaping air outlet holes 150 angle forward 45° (angle θ″=45°, FIG. 5c) and inward toward the axis 142 of rotation of the bell cup 120 at an angle of 5° (angle φ″=5°, FIG. 5d) and exhaust in the direction opposite to the direction of rotation of the bell cup 120. In this embodiment there are forty shaping air outlet holes 150 (FIGS. 5a-b) spaced equally at 9° intervals about the bell cup 120 axis 142 of rotation. The diameters of the holes 150 in this embodiment are about 0.030″ (about 0.762 mm).

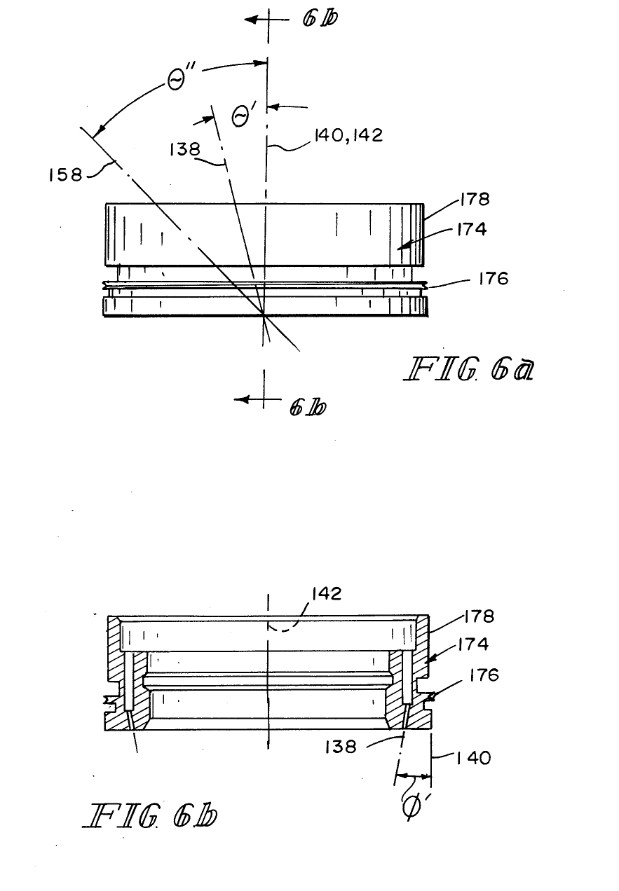

FIGS. 6a-b illustrate a dual outlet holes 130, 150 embodiment. The inner shaping air outlet holes 130 angle forward 15° (angle θ′=15°, FIG. 6a) and inward toward the axis 142 of rotation of the bell cup 120 at an angle of 10° (angle φ′=10°, FIG. 6b) and exhaust in the direction (clockwise in this embodiment) opposite to the direction of rotation of the bell cup 120 (counterclockwise in this embodiment). In this embodiment there are forty shaping air outlet holes 130 spaced equally at 9° intervals about the bell cup 120 axis 142 of rotation. The diameters of the holes 130 in this embodiment are about 0.030″ (about 0.762 mm). The outer shaping air outlet holes 150 angle forward 45° (angle θ″=45°, FIG. 6a) but are not inclined toward the axis 142 of rotation of the bell cup 120 (angle φ″=0°). The outer shaping air outlet holes 150 exhaust in the direction opposite to the direction of rotation of the bell cup 120. In this embodiment there are forty shaping air outlet holes 150 spaced equally at 9° intervals about the bell cup 120 axis 142 of rotation. The diameters of the holes 150 in this embodiment are about 0.030″ (about 0.762 mm).

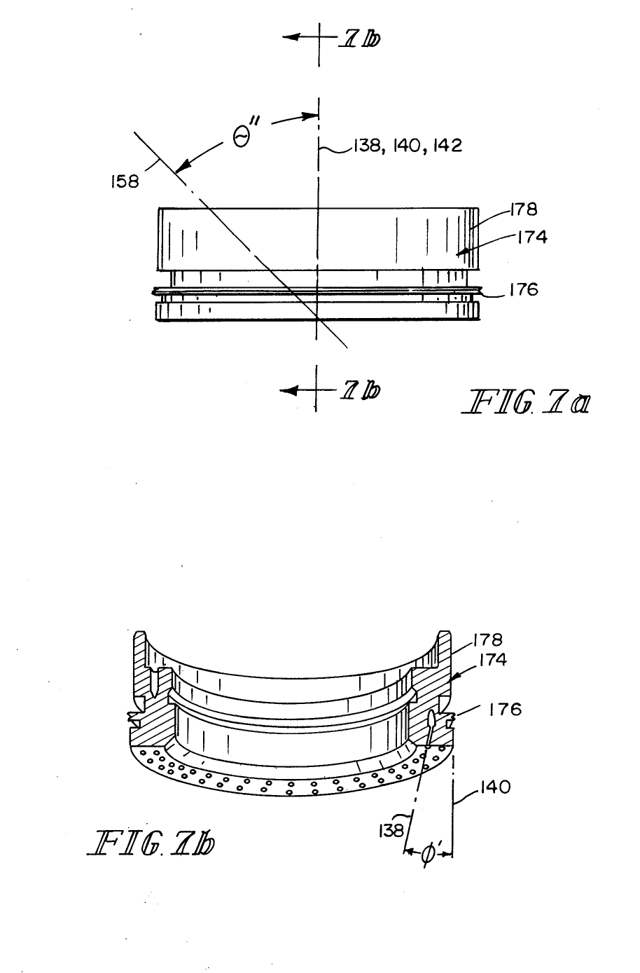

FIGS. 7a-b illustrate a dual outlet holes 130, 150 embodiment. The inner shaping air outlet holes 130 form a 0° angle forward with respect to the axis 142 of rotation of the bell cup 120 (angle θ′=0°, FIG. 7a), but do angle inward toward the axis 142 of rotation of the bell cup 120 at an angle of 10° (angle φ′=10°, FIG. 7b). In this embodiment there are forty shaping air outlet holes 130 spaced equally at 9° intervals about the bell cup 120 axis 142 of rotation. The diameters of the holes 130 in this embodiment are about 0.030″ (about 0.762 mm). The outer shaping air outlet holes 150 angle forward 45′ (angle θ″=45°, FIG. 7a), but are not angled inward toward, or outward away from, the axis 142 of rotation of the bell cup 120 (angle φ″=0°). In this embodiment there are forty shaping air outlet holes 150 spaced equally at 9° intervals about the bell cup 120 axis 142 of rotation. The diameters of the holes 150 in this embodiment are about 0.030″ (about 0.762 mm).

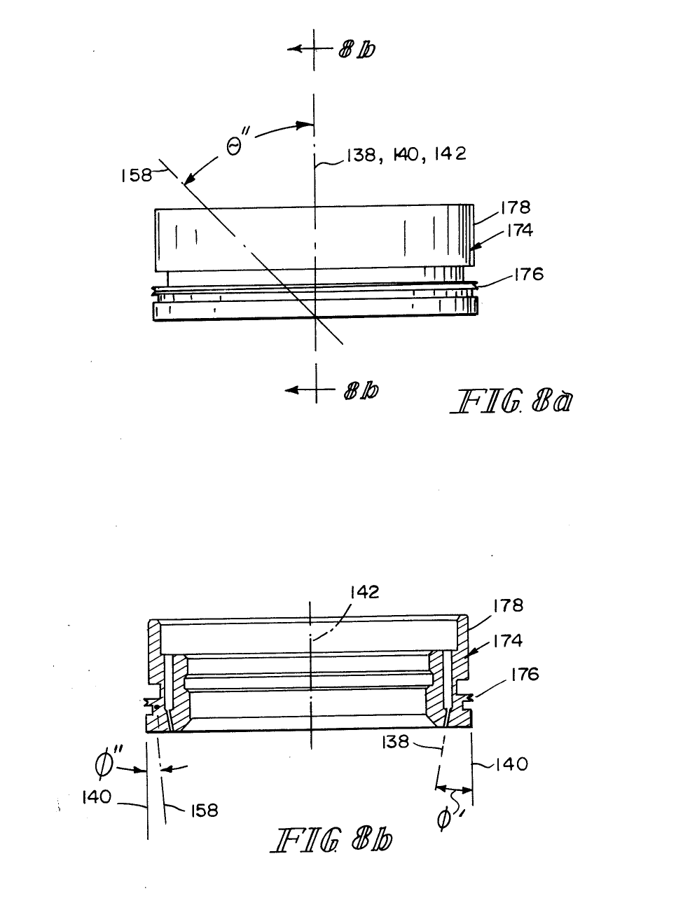

FIGS. 8a-b illustrate a dual outlet holes 130, 150 embodiment. The inner shaping air outlet holes 130 are not angled either in the direction of rotation of the bell cup 120 or in the direction opposite the direction of rotation of the bell cup 120 (angle θ′=0°, FIG. 8a), but are angled inward toward the axis 142 of rotation of the bell cup 120 at an angle of 10° (angle φ′=10°, FIG. 8b). In this embodiment there are forty shaping air outlet holes 130 spaced equally at 9° intervals about the bell cup 120 axis 142 of rotation. The diameters of the holes 130 in this embodiment are about 0.030″ (about 0.762 mm). The outer shaping air outlet holes 150 angle forward 45° (angle θ″=45°, FIG. 8a) and are angled inward toward the axis 142 of rotation of the bell cup 120 at an angle of 5° (angle φ″=5°, FIG. 8b) and exhaust in the direction (clockwise in this embodiment) opposite to the direction of rotation of the bell cup 120. In this embodiment there are forty shaping air outlet holes 150 spaced equally at 9° intervals about the bell cup 120 axis 142 of rotation. The diameters of the holes 150 in this embodiment are about 0.030″ (about 0.762 mm).

What is claimed is:

1. A coating material dispenser including a motor provided in a housing, a bell cup mounted to the motor for rotation about an axis of rotation, the housing including shaping gas outlet holes provided on a circle having a center on the axis of rotation, each hole having a longitudinal axis which makes a non-zero angle with a line which passes through an opening of the hole from the housing and extends parallel to the axis of rotation.

2. The apparatus of claim 1 wherein the non-zero angle is in a direction opposite a direction of rotation of the bell cup.

3. The apparatus of claim 1 wherein the longitudinal axes of the gas outlet holes are angled at the non-zero angles toward the axis of rotation of the motor.

4. The apparatus of claim 1 including first and second sets of shaping gas outlet holes, the holes of the first set having longitudinal axes, the holes of the second set having longitudinal axes, the holes of the first set lying generally on a first circle having a first diameter and the holes of the second set lying generally on a second circle having a second larger diameter than the first diameter.

5. The apparatus of claim 4 wherein the non-zero angle is in a direction opposite a direction of rotation of the bell cup.

6. The apparatus of claim 4 wherein the holes of the first set are provided with compressed gas through a first control and the holes of the second set are provided with compressed gas through a second control separate from the first control.

7. The apparatus of claim 4 wherein the longitudinal axis of each hole of the first set makes a non-zero angle with a line which passes through an opening of the hole of the first set and extends parallel to the axis of rotation, the longitudinal axis of each hole of the first set further making a second non-zero angle with a line which passes through an opening of the hole of the first set and is angled toward the axis of rotation of the motor, and the longitudinal axis of each hole of the second set makes a third non-zero angle with a line which passes through an opening of the hole of the second set and extends parallel to the axis of rotation.

8. The apparatus of claim 7 wherein the non-zero angle is in a direction opposite a direction of rotation of the bell cup.

9. The apparatus of claim 8 wherein the third non-zero angle is in a direction opposite a direction of rotation of the bell cup.

10. The apparatus of claim 7 wherein the holes of the first set are provided with compressed gas through a first control and the holes of the second set are provided with compressed gas through a second control separate from the first control.

11. The apparatus of claim 1 including first and second sets of shaping gas outlet holes, the holes of the first set having longitudinal axes, the holes of the second set having longitudinal axes, the longitudinal axis of each hole of the first set making a non-zero angle with a line which passes through an opening of the hole of the first set and extends parallel to the axis of rotation, the longitudinal axis of each hole of the first set further making a second non-zero angle with a line which passes through an opening of the hole of the first set and is angled toward the axis of rotation of the motor, and the longitudinal axis of each hole of the second set making a third non-zero angle with a line which passes through an opening of the hole of the second set and extends parallel to the axis of rotation.

12. The apparatus of claim 11 wherein the holes of the first set are provided with compressed gas through a first control and the holes of the second set are provided with compressed gas through a second control separate from the first control.
